(19) United States
(12) Patent Application Publication
(10) Pub. No.: US 2026/0368600 A1
(43) Pub. Date: Nov. 19, 2026

(54) METHOD FOR ESTIMATING AN OVERLAP OF A REFERENCE QUANTUM STATE AND AN EVOLVED QUANTUM STATE OF A QUANTUM SYSTEM, HYBRID QUANTUM-CLASSICAL COMPUTING SYSTEM AND COMPUTER PROGRAM PRODUCT

(71) Applicants: Max-Planck-Gesellschaft zur Förderung der Wissenschaften e.V., München (DE); President and Fellows of Harvard College, Cambridge, MA (US)

(72) Inventors: Dominik Sebastian Wild, Garching (DE); Benjamin Frederic Schiffer, Garching (DE); Juan Ignacio Cirac Sasturain, Garching (DE); Nishad Maskara, Cambridge, MA (US); Mikhail Dmitrievich Lukin, Cambridge, MA (US)

(21) Appl. No.: 19/203,694

(22) Filed: May 9, 2025

(51) Int. Cl. G06N 10/60; G06N 10/20

(52) U.S. Cl. CPC G06N 10/60; G06N 10/20

(57) ABSTRACT

A method for estimating an overlap of a reference quantum state and an evolved quantum state of a quantum system, the evolved quantum state resulting from an evolution of an initial quantum state of the quantum system under a system unitary evolution having a description in terms of local operators that act on corresponding local subsystems of the quantum system, wherein the method comprises:
executing a plurality of quantum algorithms to thereby obtain a plurality of computational results indicative of a data series of phase information of the overlap, wherein each of the quantum algorithms requires at least one dedicated auxiliary quantum system associated with one of the local operators in a one-to-one correspondence and the execution of the quantum algorithm comprises:
providing a total quantum system including the quantum system prepared in the initial quantum state and the at least one auxiliary quantum system prepared in an initial auxiliary quantum state;
evolving the total quantum system under a total unitary evolution, wherein a joint action of the total unitary evolution on the quantum system and the at least one auxiliary quantum system is limited to each auxiliary quantum system and the corresponding subsystem of its associated local operator and is determined by the associated local operator;
applying a projective quantum measurement onto the reference quantum state to the quantum system and applying an auxiliary quantum measurement to the at least one auxiliary quantum system to thereby obtain the computational result.

The present invention is related to a method for estimating an overlap of a reference quantum state and an evolved quantum state of a quantum system, the evolved quantum state resulting from an evolution of an initial quantum state of the quantum system under a system unitary evolution having a description in terms of local operators that act on corresponding local subsystems of the quantum system. The invention further relates to a hybrid quantum-classical computing system, a computer program product and a computer-readable storage medium for carrying out the method.

Estimating the overlap of a reference quantum state and an evolved quantum state is important, e.g., for quantum phase estimation. Quantum phase estimation algorithms play a central role in quantum computation, in particular in quantum simulation and metrology. Quantum phase estimation allows for precise eigenvalue estimation and thereby enables, among others, the study of spectral properties in many-body quantum systems. The overlap of a reference quantum state and an evolved quantum state also finds application to compute observables as a function of the internal energy of the many-body quantum system. The existence of a method to efficiently compute this overlap is thereby instrumental to efficiently simulate quantum processes on quantum hardware which is crucial for advantages in condensed matter physics, quantum chemistry and material science, providing insights into strongly correlated materials, molecular structures and non-equilibrium dynamics. Furthermore, when the initial quantum state is identical to the reference quantum state, the overlap mentioned above is also known as the complex Loschmidt echo. The complex Loschmidt echo is a fundamental concept in statistical physics, with its absolute value squared capturing the probability of a quantum system returning to its initial state after a unitary evolution. The Loschmidt echo generally contains information about many-body properties of the quantum system and is also relevant in a variety of fields including quantum chaos, many-body physics or high-energy physics.

In theory, the known Hadamard test allows to determine the overlap of the evolved quantum state and the reference quantum state (at least for the case that the initial quantum state is identical to the reference quantum state) by a controlled application of the system unitary evolution to the quantum system, the application being controlled by a quantum state of an auxiliary quantum system. While this approach is simple in theory, the controlled application of the system unitary evolution to the quantum system is a highly non-trivial endeavor in practice. In particular, it may require a large circuit depth which hinders an efficient and reliable execution of the Hadamard test on available quantum hardware.

Due to the high relevance of quantum phase estimation, various alternative approaches to estimate the overlap have been proposed in the art. A first line of research is dedicated to Improve the efficiency of quantum phase estimation algorithms that require an auxiliary quantum system. To this end, WO 2024/095008 A1 discloses variational quantum phase estimation algorithms that use an auxiliary system and a variational fast-forwarding method to generate time-involved quantum states. EP 2 979 230 B1 discloses a method for quantum phase estimation that comprises an application of a first random phase to the auxiliary quantum system and a second random phase to the quantum system. U.S. Pat. No. 11,176,478 B2 discloses a method for quantum phase estimation that comprises providing a plurality of quantum circuits connected in series, wherein an output of a first quantum circuit of the plurality of quantum circuits is an input of a second quantum circuit of the plurality of quantum circuits. Thereby, the quantum phase may be determined with a reduced and minimized number of quantum measurements.

As noisy intermediate term quantum computers (NISQ computers) have not reached fault tolerance yet, several approaches for quantum phase estimation have been proposed in the art that aim at reducing the number of controlled operations in each circuit. For example, arXiv:2304.05126v1 “Statistical Phase Estimation and Error Mitigation on a Superconducting Quantum Processor” by N. Blunt et al. discloses a method that determines a time series of phase information indicative of the overlap by applying the standard Hadamard test with a controlled application of a unitary evolution up to different points in time. arXiv:2010.02538v1 “Error Mitigation via Verified Phase Estimation” by T. O'Brien et al. discloses a method for error mitigation of a quantum phase estimation experiment with and without an auxiliary quantum system.

Another approach to overcome the problem of the large circuit depth required by the global controlled operation of the Hadamard test is presented, for example, in Y. Yang et. al “Phase-sensitive Quantum Measurement without Controlled Operations”, arXiv:2308.10769v2, which is restricted to initial states with short-ranged correlations. L. Clinton et al. propose ideas building on classical signal processing techniques in “Quantum Phase Estimation without Controlled Unitaries”, arXiv: 2410.21517v2, however, the practical realization could prove very challenging, and the signal processing methods are of heuristic nature and lack performance guarantees. The methods proposed in both papers do not require an auxiliary quantum system.

Despite the progress in the art of quantum phase estimation, there is still a need for efficient methods for estimating an overlap of a reference quantum state and an evolved quantum state.

This problem is solved according to a first aspect of the present invention by a method for estimating an overlap of a reference quantum state and an evolved quantum state of a quantum system, the evolved quantum state resulting from an evolution of an initial quantum state of the quantum system under a system unitary evolution having a description in terms of local operators that act on corresponding local subsystems of the quantum system, wherein the method comprises:
executing a plurality of quantum algorithms to thereby obtain a plurality of computational results indicative of a data series of phase information of the overlap, wherein each of the quantum algorithms requires at least one dedicated auxiliary quantum system associated with one of the local operators in a one-to-one correspondence and the execution of the quantum algorithm comprises:
providing a total quantum system including the quantum system prepared in the initial quantum state and the at least one auxiliary quantum system prepared in an initial auxiliary quantum state;
evolving the total quantum system under a total unitary evolution, wherein a joint action of the total unitary evolution on the quantum system and the at least one auxiliary quantum system is limited to each auxiliary quantum system and the corresponding subsystem of its associated local operator and is determined by the associated local operator;
applying a projective quantum measurement onto the reference quantum state to the quantum system and applying an auxiliary quantum measurement to the at least one auxiliary quantum system to thereby obtain the computational result.

The method according to the first aspect of the present invention does not require a global control of the whole quantum system by a quantum state of an auxiliary quantum system (e.g., a qubit) but only requires interactions between each auxiliary quantum system and an associated subsystem of the quantum system. Thereby, the depth of the quantum algorithm may be reduced compared to the prior art, and the method may be implemented efficiently and reliably.

The execution of each quantum algorithm may be by a quantum processor in one example, but the invention is not limited to this. A quantum processor is based on the laws of quantum mechanics and processes quantum information stored in quantum mechanical systems, e.g., qubits. The quantum processor may be a superconducting quantum processor, an ion quantum processor, a neutral atom quantum processor, a photonic quantum processor, etc. in one example, but is not limited to this. In one example, the quantum processor may comprise the quantum system and the at least one auxiliary quantum system, state preparation means configured to prepare the quantum system in the initial quantum state and configured to prepare the at least one auxiliary quantum system in the initial auxiliary quantum state, means to evolve the total quantum system under the total unitary evolution and measurement means configured to apply the projective quantum measurement onto the reference quantum state to the quantum system and configured to apply the auxiliary quantum measurement to the auxiliary quantum system.

The reference quantum state, the initial quantum state and the evolved quantum state may be pure or mixed quantum states, and they may be separable or entangled quantum states in one example. When the initial and reference quantum states are pure quantum states, and the system unitary is denoted by U_{sys}, the overlap of the reference quantum state and the evolved quantum state may be denoted as g= [symbol] ψ_{ref}|U_{sys}|ψᵢₙᵢ [symbol] =re^{iφ}, 1≥r≥0, and 0≤φ<2π is called the phase of the overlap, wherein |ψᵢₙᵢ [symbol] is the initial quantum state, |ψ_{ref} [symbol] is the reference quantum state, U_{sys}|ψᵢₙᵢ [symbol] is the evolved quantum state. In particular the overlap is a complex overlap, i.e., a complex number. In certain examples, the initial quantum state is identical to the reference quantum state. In this case, the overlap may also be denoted as the complex Loschmidt echo. The invention is not limited to this, though.

Within this specification, a quantum system is in particular a quantum system that allows to define local subsystems. each being a part of the whole quantum system. I.e., the local subsystems are true subsystems of the quantum system, i.e., they are not identical to the quantum system. In one example, the quantum system may be a quantum many-body system comprising a plurality of K>1 quantum mechanical particles or modes, for example, qudits, in particular qubits, fermions, bosons, etc. (A qudit is a quantum mechanical d-level system with d≥2. A qubit is a qudit with d=2.) Then, each local subsystem may comprise a true subset 1≤k<K of quantum mechanical particles or modes and the corresponding local operators act non-trivially on each particle or mode of the subsystem. Each particle or mode has a distinct Hilbert space associated therewith. In one example, the Hilbert space of the quantum system may be a tensor product of the Hilbert spaces of K≥2 distinct Hilbert spaces, each being associated with a particle or mode, e.g., a qubit or a fermionic or a bosonic mode. A “local subsystem” is not necessarily local in space, but it may be local in space in certain examples. However, the invention is not limited to the above.

The system unitary evolution has a description in terms of N>1 local operators which may be denoted as O₁, . . . , O_{N} throughout this specification. Examples of such descriptions are presented below. Each of the N local operators Oⱼ, j=1, . . . , N acts only on a corresponding local subsystem Sⱼ of the quantum system. The local operator Oⱼ may be a k-local operator. That is, when the quantum system comprises a plurality of particles or modes, the k-local operator acts only on k<K of the K particles or modes. Pairs of subsystems may either be identical, disjoint or may have a non-vanishing overlap. At least two of the local subsystems are different from each other.

Within this specification, every quantum algorithm acts on a total quantum system that comprises the quantum system and the at least one auxiliary quantum system. Every quantum algorithm comprises a sequence of instructions to prepare the quantum system of the total quantum system in the initial quantum state and to prepare the at least one auxiliary quantum system in the initial auxiliary quantum state, to evolve the total quantum system under a total unitary evolution and to apply the projective quantum measurement onto the reference quantum state to the quantum system and to apply the auxiliary quantum measurement to the at least one auxiliary quantum system to thereby obtain a computational result associated with the quantum circuit. In particular, the initial auxiliary quantum state and/or the auxiliary quantum measurement may be the same for each quantum algorithm. For two different quantum algorithms the associated total unitary evolutions are different from each other.

Executing the quantum algorithm comprises running the quantum algorithm M≥1 times (M shots) to obtain for each run (shot) an associated measurement outcome from the application of the quantum measurements. The number M of shots may be the same or may be different for two different quantum algorithms. The associated measurement outcome of each shot may comprise the measurement outcome of the projective quantum measurement onto the reference quantum state, and additionally, in certain embodiments, the measurement outcome of the auxiliary quantum measurement. In one example, the computational result associated with the quantum algorithm may comprise at least one measurement outcome of the M shots or each measurement outcome of the M shots or the computational result associated with the quantum algorithm may be obtained from the measurement outcomes of the M shots, for example, via averaging, as it is well-known in the art of quantum computation. In particular, the computational result may comprise an estimator value of an expectation value of an observable in certain examples.

Each quantum algorithm requires at least one dedicated auxiliary quantum system ASⱼ associated with one of the local operators Oⱼ in a one-to-one correspondence. That is, each quantum algorithm is associated with at least one and at most N local operators of the description of the system unitary evolution in terms of N local operators and requires for each of the associated local operators Oⱼ one dedicated auxiliary quantum systems ASⱼ. The auxiliary quantum systems are in particular pairwise disjoint, that is. they do not overlap.

For ease of notation, the at least one auxiliary quantum system required by the quantum algorithm may also be denoted as an ancilla system within this specification. That is, the ancilla system comprises the at least one auxiliary quantum system. The action of the total unitary evolution on the total quantum system of the quantum system and the ancilla system comprises the joint action on the quantum system and the ancilla system and may further comprise an action limited to the quantum system and/or an action limited to the ancilla system, in one example. When the total unitary evolution jointly acts on the quantum system and the ancilla system, each auxiliary quantum system ASⱼ only interacts with the corresponding subsystem Sⱼ of its associated local operator Oⱼ, and the interaction is determined by the associated local operator Oⱼ. In one example, the total unitary evolution may comprise for each auxiliary quantum system ASⱼ at least one associated unitary Uⱼ that jointly evolves the auxiliary quantum system ASⱼ and the subsystem Sⱼ corresponding to its associated local operator Oⱼ, wherein the associated unitary Uⱼ is determined by the local operator Oⱼ. In one example, the total unitary evolution comprises for each auxiliary quantum system a single associated unitary Up.

The execution of each quantum algorithm comprising an application of a projective quantum measurement onto the reference quantum state, |ψ_{ref} [symbol] [symbol] ψ_{ref}|, to the quantum system. In particular, the projective quantum measurement may be carried out at the end of the joint unitary evolution in one example. In one expedient example, the projective quantum measurement onto the reference quantum state may be carried out as follows: Many reference quantum states of Interest may be obtained from an evolution of an initial unentangled computational basis state of a quantum processor, e.g., |init [symbol] =|10 [symbol] ⊗|0 [symbol] ⊗ . . . ⊗|0 [symbol] under a reference unitary evolution U_{ref}, i.e., |ψ_{ref})=U_{ref}|init [symbol] . The projective quantum measurement onto the reference quantum state |ψ_{ref} [symbol] [symbol] ψ_{ref}| may then be carried out by applying the reverse reference transformation

$${U}_{ref}^{†}$$

before a computational basis measurement,

$$\vert {ψ}_{ref} 〉 〈 {ψ}_{ref} \vert = {U}_{ref} \vert init 〉 〈 init \vert {U}_{ref}^{†} .$$

The computational basis measurement may be realized by taking snap shots in the computational basis and counting the occurrences of the initial unentangled computational basis state |init [symbol] .

The execution of each quantum algorithm also comprises applying an auxiliary quantum measurement to the auxiliary quantum system. The auxiliary quantum measurement may comprise for each auxiliary quantum system a dedicated auxiliary quantum measurement that only measures the one auxiliary quantum system. The auxiliary quantum measurement(s) may be applied before, simultaneous with or after the projective quantum measurement onto the reference quantum state in one example. In particular, the auxiliary quantum measurement(s) may comprise a measurement of a Pauli operator or a computational basis measurement. In one example, the auxiliary quantum measurement may comprise for each auxiliary quantum system a measurement of at least one Pauli operator, e.g., the Pauli-X and/or Pauli-Y operator. or a computational basis measurement.

The plurality of computational results allows to estimate at least the phase of the overlap. In one example, the data series of phase information of the overlap comprises a time series of phase information of the overlap, but the invention is not limited to this.

In some examples of the method according to the first aspect of the present invention, the method may further comprise determining a value of an overlap of the Initial quantum state and the reference quantum state, i.e., [symbol] _{ref}|ψᵢₙᵢ [symbol] . This may be achieved by use of a quantum processor or a classical processor in one example. For example, consider that |ψᵢₙᵢ [symbol] =V₁|init [symbol] , with |init [symbol] =|0 [symbol] ⊗|0 [symbol] ⊗ . . . ⊗|0 [symbol] the computational basis state that the quantum processor is initialized in, and V₁ a unitary operation. Similarly, |ψ_{ref} [symbol] =V₂|init [symbol] , wherein V₂ is a unitary operation. Then, the overlap of the initial quantum state and the reference quantum state may be written as

$$〈 {ψ}_{ref} \vert {ψ}_{ini} 〉 = 〈 init \vert {V}_{2}^{†} {V}_{1} \vert init 〉 .$$

Hence, the task of computing [symbol] ω_{ref}|ψᵢₙᵢ [symbol] may be formulated as finding the overlap of a Loschmidt echo with a unitary

$${V}_{2}^{†} {V}_{1}$$

and may be solved according to the method of the present invention.

In one embodiment of the method according to the first aspect of the present Invention, the plurality of quantum algorithms may comprise for at least one local operator of the description of the system unitary evolution in terms of local operators a quantum algorithm that requires a single auxiliary quantum system associated with the one local operator. As the quantum algorithm requires only one single auxiliary quantum system, the required quantum resources are limited. Furthermore, the quantum algorithm may be executed very efficiently. In one example, the plurality of quantum algorithms may comprise for each local operator of the description of the system unitary evolution in terms of local operators a quantum algorithm that requires a single auxiliary quantum system associated with the one local operator.

In another embodiment of the method according to the first aspect of the present invention, at least one quantum algorithm requires for each local operator of the description of the system unitary evolution in terms of local operators an associated auxiliary quantum system. In one example of the embodiment, each quantum algorithm requires for each local operator of the description of the system unitary evolution in terms of local operators an associated auxiliary quantum system. In certain examples, this may allow the estimation of the overlap with fewer quantum algorithms compared to other embodiments.

In yet another embodiment of the method according to the first aspect of the present Invention, the total unitary evolution of at least one quantum algorithm may further comprise an evolution of the quantum system under the system unitary evolution up to a specific point in time. The system unitary evolution may be expressed via its generating Hamiltonian H as U_{sys}=e^{-iHt}, wherein t>0 is a time. Then, the evolution of the quantum system under the system unitary evolution up to the specific point t₅ in time may be described by the unitary U_{sys}(tₛ)=e^{-iHt}ₛ. In one example, the plurality of quantum algorithms may comprise for each of a plurality of points in time at least one quantum algorithm that comprises an evolution of the quantum system under the system unitary evolution up to the point in time. This Includes the case where the system unitary evolution has a description in terms of a plurality of generating Hamiltonians Hⱼ and a plurality of unitaries Uⱼ, as U_{sys}=e^{-iH}^{₁}^{t}^{₁}U₁e^{-iH}^{₂}^{t}^{₂}U₂ . . . e^{-H}^{_{K}}^{t}^{_{K}}.

In one embodiment of the method according to the first aspect of the present invention, the description of the system unitary evolution in terms of local operators may comprise a sequence of local unitary operators or a set of local Hamiltonian operators. I.e., each local operator of the description may be a local unitary operator or a local Hamiltonian that acts on a corresponding local subsystem of the quantum system. In one example of the embodiment, the system unitary evolution U_{sys} may have a description in terms of a sequence of the form u_{N}·u_{N-1}· . . . ·u₂·u₁, wherein uⱼ is a unitary operator that acts only on the subsystem Sⱼ. This description may correspond to an exact decomposition of the system unitary evolution in one example, i.e., U_{sys}=u_{N}·u_{N-1}· . . . ·u₂·u₁. In another example, the description may correspond to an approximation of the system unitary evolution, U_{sys}≈u_{N}·u_{N-1}· . . . ·u₂·u₁, e.g., obtained via a Trotter decomposition of the system unitary evolution. In one example, the description may be obtained from a first order Trotter decomposition of the system unitary evolution. In another example, the description may be a set of local Hamiltonian operators {h₁, h₂, . . . , h_{N-1}, h_{N}}, wherein hⱼ is a local Hamiltonian operator acting only on the subsystem hⱼ. The sum of the local Hamiltonian operators of the set is a Hamiltonian

$$H = {\sum }_{j = 1}^{N} {h}_{j}$$

that may generate the system unitary evolution or an approximation thereof, U_{sys}=e^{-iHt} or U_{sys}≈e^{-iHt} in certain examples. In some non-limiting examples t=1. In one example, each local Hamiltonian may be a unitary operator or may be proportional to a unitary operator. In one example where the quantum system comprises a plurality of K qubits, all local Hamiltonians hⱼ may be Pauli strings or may be proportional to Pauli strings that act on a subset of 1≤kⱼ<K qubits. I.e., each local Hamiltonian hⱼ is of the form

$${λ}_{j} {⊗}_{q = 1}^{K} {P}_{q} ,$$

wherein λⱼ is a real number, P_{q}∈{I_{q}, X_{q}, Y_{q}, Z_{q}} is either the Pauli-X, -Y, or -Z operator or the identity operator acting on the qubit q, and only kⱼ of the K operators of the tensor product are different from the identity. In one example, kⱼ is the same for all local Hamiltonians hⱼ.

In yet another embodiment of the method according to the first aspect of the present invention, the joint action of the total unitary evolution on at least one of the auxiliary quantum systems and the corresponding subsystem of its associated local operator may comprise for at least one of the quantum algorithms a controlled application of the associated local operator to the subsystem controlled by a quantum state of the auxiliary quantum system. In one example where the local operator is a unitary operator or is proportional to a unitary operator, the joint action may comprise a controlled unitary operation on the subsystem controlled by the quantum state of the auxiliary quantum system. In this embodiment, every auxiliary quantum system controls only its associated subsystem with the controlled application of the unitary evolution, unlike the Hadamard test that requires a global controlled unitary operation.

In one embodiment of the method according to the first aspect of the present invention, the quantum system and/or the at least one auxiliary quantum system may be a qudit system, in particular a qubit system. That is, the quantum system and/or the at least one auxiliary quantum system comprises a plurality of qudits, or a plurality of qubits. When the quantum system comprises a plurality of qudits, e.g., K qudits, each local operator Oⱼ of the description in terms of local operators may act only on a subsystem Sⱼ that consists of a subset of 1≤kⱼ<K qudits. In particular, kⱼ=4, 3 or 2 in one example. In one example, each auxiliary quantum system may be a qudit system or a qubit system, i.e., a system that comprises at least one qudit or qubit. In one example, each auxiliary quantum system is a qubit system, and each of these qubits is prepared in the computational zero state |0 [symbol] . In one example of the embodiment, each auxiliary quantum system may be a qudit, and in particular a qubit. In one example, each auxiliary quantum system may be a qubit, and the initial auxiliary quantum state of each of these qubits may be the state

$$\vert + 〉 = \frac{1}{√ 2} ( \vert 0 〉 + \vert 1 〉 ) .$$

For example, such an initial state may be prepared when the joint action of the total unitary evolution on the auxiliary quantum system and the subsystem of the associated local operator is a controlled application of the local operator that is controlled by the quantum state |+ [symbol] of the auxiliary quantum system.

In yet another embodiment of the method according to the first aspect of the present invention, the initial auxiliary quantum state may be a separable quantum state. That is, the initial auxiliary quantum state is not entangled. Separable quantum states are easier to prepare than entangled quantum states, whereby the efficiency of the method according to the first aspect of the present invention may be improved.

In yet another embodiment of the method according to the first aspect of the present invention, the method may further comprise estimating at least a phase φ of the overlap on the basis of the computational results. In one example, the method may further comprise estimating the amplitude r of the overlap g= [symbol] ψ_{ref}|U_{sys}|ψᵢₙᵢ [symbol] =re^{iφ}. Estimating at least the phase of the overlap on the basis of the computational results may be performed by a classical computer in one example. A classical computer comprises a classical processor that processes classical bits. In one example, the plurality of quantum algorithms may be executed by a quantum processor, the quantum processor may be connected to the classical computer via a network, e.g., a wireless network or a LAN network and the quantum processor may be configured to transmit the computational results to the classical processor via the network. In one example, the classical computer and the quantum computer may be arranged at remote locations. In one example, the classical computer and/or the quantum processor may be part of a cloud computer.

In one example of the embodiment, the plurality of computational results may be indicative of a data series of time derivatives of a phase of the overlap at different points in time. In one example of the embodiment, the method may comprise a numerical integration of the time derivatives of the phase,

$$\frac{d ϕ}{dt} {\vert}_{{t}_{α}} α = 1 , ... , L ,$$

to thereby obtain the phase φ of the overlap g= [symbol] ψ_{ref}|U_{sys}ψᵢₙᵢ [symbol] =re^{iφ}. The numerical integration may be carried out on a classical computer in one example.

In one embodiment of the method according to the first aspect of the present invention, the description of the system unitary evolution in terms of local operators may comprise a sequence of local unitary operators, and the plurality of quantum algorithms may comprise for each local unitary operator of the description of the system unitary evolution in terms of local operators a quantum algorithm that requires a single auxiliary quantum system associated with the one local unitary operator so as to form a series of quantum algorithms from an initial quantum algorithm that is associated with an initial local unitary operator and includes an initial total unitary evolution that comprises the controlled application of the initial local unitary operator to its corresponding subsystem controlled by the quantum state of the auxiliary quantum system to a final quantum algorithm of the series of quantum algorithms, wherein a subsequent total unitary evolution of a subsequent quantum algorithm of the series of quantum algorithms differs from a preceding total unitary evolution of a preceding quantum algorithm of the series of quantum algorithms in that a control is removed from a previously controlled local unitary operator associated with the preceding quantum algorithm and a controlled application of a local unitary operator associated with the subsequent quantum algorithm to its corresponding subsystem is added at a position in accordance with the sequence of local unitary operators. This embodiment requires one single auxiliary quantum system for each quantum algorithm and only one single controlled application of the local unitary operator to its subsystem. Thereby, the quantum algorithms may be executed very efficiently. This embodiment is particularly well-suited for digital quantum devices as it relies on sequentially controlling each of the local unitary operators of the description of the system unitary operator. The embodiment may also be used for Floquet-engineered Hamiltonians which may be a powerful technique when the target Hamiltonian cannot be realized directly. In one example, the initial total unitary evolution may consist of the controlled application of the initial local unitary operator to its corresponding subsystem controlled by the quantum state of the auxiliary quantum system. In one example, at least one subsequent total unitary evolution may differ from the preceding total unitary evolution only in that the control is removed from the previously controlled local unitary operator associated with the preceding quantum algorithm and the controlled application of the local unitary operator associated with the subsequent quantum algorithm to its corresponding subsystem is added at the position in accordance with the sequence of local unitary operators. In one example, each subsequent total unitary evolution may differ from the preceding total unitary evolution only in that the control is removed from the previously controlled local unitary operator associated with the preceding quantum algorithm and the controlled application of the local unitary operator associated with the subsequent quantum algorithm to its corresponding subsystem is added at the position in accordance with the sequence of local unitary operators.

In the embodiment, the description of the system unitary evolution U_{sys} in terms of local operators comprises a sequence of local unitary operators u_{N}·u_{N-1}· . . . ·u₂·u₁, wherein the local unitary operators uⱼ are applied sequentially from u₁ to u_{N}. The description may correspond to an exact decomposition of the system unitary evolution, i.e., U_{sys}=u_{N}·u_{N-1}· . . . ·u₂·u₁ or it may correspond to an approximation thereof, i.e., U_{sys}≈u_{N}·u_{N-1}· . . . ·u₂·u₁. Each local unitary operator uⱼ acts only on the subsystem Sⱼ of the quantum system. The plurality of quantum algorithms comprises a series of quantum algorithms A₁, . . . , A_{N} from the initial quantum algorithm A₁ to the final quantum algorithm A_{N}. Each quantum algorithm Aⱼ of the series is associated with one of the local operators u_{π(j)} in a one-to-one correspondence, wherein π:{1, . . . , N}→{1, . . . , N}, j [symbol] π(j) is a permutation. In one example of the embodiment, the initial total unitary evolution of the initial quantum algorithm A₁ associated with the initial local unitary operator u_{π(1)} consists of the controlled application of the local unitary operator u_{π(1)} to its corresponding subsystem S_{π(1)} controlled by the quantum state of the auxiliary quantum system. This operation may also be denoted by c-u_{π(1)} applied to the subsystem and the auxiliary quantum system throughout this specification. Similarly, the application of the operation c-u_{π(j)} to the subsystem S_{π(j)} and the auxiliary quantum system is defined as the controlled application of the local unitary operator u_{π(j)} to its corresponding subsystem S_{π(j)} controlled by the quantum state of the auxiliary quantum system. The second total unitary evolution of the second quantum algorithm A₂ associated with the local unitary operator u_{π(j)} differs from the initial total unitary evolution in that the control from c-u_{π(1)} is removed and c-u_{π(2)} is added at the position in accordance with the sequence u_{N}·u_{N-1}· . . . ·u₂·u₁. I.e., in one example, the second total unitary evolution of the second quantum algorithm is either a unitary evolution of the quantum system with local unitary operator u_{π(1)} followed by the application of c-u_{π(2)} to the auxiliary quantum system and the subsystem S_{π(2)} (which, by slight abuse of notation, is abbreviated as c-u_{π(2)} u_{π(1)} in the following) if π(1)<π(2), and otherwise, if π(1)>π(2), the second total unitary evolution of the second quantum algorithm is the application of c-u_{π(2)} on the auxiliary quantum system and the subsystem S_{π(2)} followed by the unitary evolution of the quantum system under the local unitary operator u_{π(1)} (abbreviated as u_{π(2)} c-u_{π(2)}). The third total unitary evolution of the third quantum algorithm A₃ associated with the local unitary operator u_{π(3)} differs from the second total unitary evolution of the second quantum algorithm in that the control is removed from c-u_{π(2)} and c-u_{π(3)} is added at the position in accordance with the sequence u_{N}·u_{N-1}· . . . ·u₂·u₁. I.e., in one example, if π(1)<π(2)<π(3), the third total unitary evolution of the third quantum algorithm A₃ is c-u_{π(3)}π_{π(2)}u_{π(1)}, if π(2)<π(1)<π(3), the third total unitary evolution of the third quantum algorithm A₃ is c-u_{π(3)} u_{π(1)} u_{π(2)}, if π(1)<π(3)<π(2), the third total unitary evolution of the third quantum algorithm A₃ is u_{π(2)} c-u_{π(3)} u_{π(2)}, if π(2)<π(3)<π(1), the third total unitary evolution of the third quantum algorithm A₃ is u₍₁₎ c-u_{π(3)} u_{π(2)}, if π(3)<π(2)<π(1), the third total unitary evolution of the third quantum algorithm A₃ is u_{π(1)} u_{π(2)} c-u_{π(3)}, and if π(3)<π(1)<π(2), the third total unitary evolution of the third quantum algorithm A₃ is u_{π(2)} u_{π(1)} c-u_{π(3)}. The other quantum algorithms of the series of quantum algorithms are defined in a similar way.

In one example of the embodiment, the permutation n is the identity, and the j-th quantum algorithm of the series of quantum algorithms is associated with the local unitary operator uⱼ and its total unitary evolution may be of the form C-uⱼ uⱼ₋₁uⱼ₋₂ . . . u₁.

In one example of the embodiment, the initial quantum state of the single auxiliary quantum state may be the |+ [symbol] state for all quantum algorithms. In one example of the embodiment, the auxiliary quantum measurement of the auxiliary quantum system may be a measurement of the Pauli-X and/or Pauli-Y operators.

In one example, the embodiment may further comprise estimating the overlap by applying a recursive formula to the computational results.

In another embodiment of the method according to the first aspect of the present invention, the description of the system unitary evolution may comprise a set of local Hamiltonian operators, and the plurality of quantum algorithms may comprise for each of the local Hamiltonians and each of a plurality of points in time an associated quantum algorithm that requires a single auxiliary quantum system associated with the one local Hamiltonian, wherein the total unitary evolution comprises an evolution of the quantum system under the system unitary evolution up to the point in time, and the joint action of the total unitary evolution comprises the controlled application of an operator derived from the local Hamiltonian operator to its corresponding subsystem controlled by the quantum state of the auxiliary quantum system.

In the embodiment, the description of the system unitary evolution comprises the set of local Hamiltonian operators {h₁, h₂, . . . , h_{N-1}, h_{N}}, wherein each hⱼ is a local Hamiltonian that acts only on the subsystem Sⱼ of the quantum system. The sum of these local Hamiltonian operators,

$$H = {\sum }_{j = 1}^{N} {h}_{j} ,$$

may generate the system unitary evolution U_{sys}=e^{-iHt} or an approximation thereof, i.e., U_{sys}≈e^{-iHt} in one example, t=1, but the invention is not limited to this. The plurality of quantum algorithms comprises for each of the local Hamiltonians hⱼ and each of a plurality of points in time t_{α}, α=1, . . . , L, t₁<t₂< . . . <t_{L}, an associated quantum algorithm A_{j,α} that requires a single auxiliary quantum system, and wherein the total unitary evolution of the quantum algorithm comprises the unitary evolution of the quantum system under the system unitary up to the point in time t_{α}, i.e., e^{-iHt}^{_{α}} and the controlled application of an operator derived from the local Hamiltonian operator hⱼ to its associated subsystem Sⱼ controlled by the quantum state of the single auxiliary quantum system. In one example, the description of the system unitary evolution may be such that at least one local Hamiltonian is proportional to a unitary operator, hⱼ=λⱼuⱼ for some real λⱼ (including the case Aⱼ=1), and the controlled application of the operator derived from the local Hamiltonian may comprise the controlled application of the unitary operator uⱼ to the subsystem Sⱼ controlled by the quantum state of the auxiliary system. In one expedient example, the description of the system unitary evolution may be such that all local Hamiltonians are proportional to unitary operators, i.e., hⱼ=λⱼuⱼ (including the case λⱼ=1). Then, each controlled application of the operator derived from the local Hamiltonian operator hⱼ may be a controlled application of the unitary operator uⱼ to the subsystem Sⱼ controlled by the quantum state of the auxiliary system. In one example where the quantum system comprises a plurality of K qubits, all local Hamiltonians may be proportional to Pauli strings that act on a subset of k qubits. I.e., each local Hamiltonian hⱼ is proportional to

$${\hat{P}}_{j} = {⊗}_{q = 1}^{K} {P}_{q}^{( j )} ,$$

wherein

$${P}_{q}^{( j )} ∈ \{ {I}_{q} , {X}_{q} , {Y}_{q} , {Z}_{q} \}$$

is either the Pauli-X, -Y, or -Z operator or the identity operator acting on the qubit q, and only 1≤k<K of the K operators are different from the Identity. In one example, all local Hamiltonians hⱼ may be proportional to Pauli strings that act on a corresponding subset of k qubits and the plurality of quantum algorithms comprises for each of the local Hamiltonians hⱼ and each of a plurality of points in time t_{α}, α=1, . . . , L, t₁<t₂< . . . <t_{L}, an associated quantum algorithm A_{j,α} that requires a single auxiliary quantum system, and wherein the total unitary evolution comprises the unitary evolution of the quantum system under the system unitary up to the point in time, i.e., e^{-iHt}^{ⱼ} followed by the controlled application of the Pauli string \hat{P}ⱼ to the associated subsystem Sⱼ controlled by the quantum state of the single auxiliary quantum system. For each quantum algorithm, the initial auxiliary quantum state of the auxiliary quantum system may be the |+>-state, and the auxiliary quantum measurement may be a Pauli-X measurement. The computational results may allow to construct a time series of the time derivative of the phase of the overlap. In one example of the embodiment, the method may further comprises estimating the phase by numerically integrating the time series of the time derivatives of the phase.

In one example of the embodiment, the system unitary evolution may be an analogue time dynamics. Then, the method may, for example, be implemented by use of hybrid analogue-digital quantum device. However, the invention is not limited to this.

In yet another embodiment of the method according to the first aspect of the present invention, the auxiliary quantum measurement may comprise for at least one auxiliary quantum system an independent measurement of the auxiliary quantum system resulting in a measurement outcome associated therewith, and wherein depending on an appropriate post-selection of the associated measurement outcome an action of the joint unitary evolution on the corresponding subsystem of its associated local operator may comprise an imaginary time evolution determined by the local operator, and the method comprises the appropriate post-selection. To be entirely clear, an “independent measurement of the auxiliary quantum system” means that this measurement does not affect the other auxiliary quantum systems. The method according to the embodiment relies on post-selection. The computational results of the embodiment comprise data indicative of the phase gradient at different points t_{α} in time. The phase gradient at the point t_{α} in time is in particular a time-derivative of the phase at the point t_{α} in time

$$\frac{d ϕ}{dt} {\vert}_{{t}_{α}} .$$

The embodiment makes use of the fact that any non-unitary operator, and thereby every imaginary time evolution operator, may be implemented as a unitary operator acting on an extended subspace that includes an auxiliary quantum system. The method is also suitable to be executed on a hybrid analogue-digital quantum devices.

In particular, the description of the system unitary evolution in terms of local operators may comprise a sequence of local unitary operators u_{N}· . . . , u₁ or, a set of the local Hamiltonian operators {h₁, . . . , h_{N}}. The imaginary time evolution determined by the local unitary operators uⱼ may be

$${B}_{j} = {e}^{+ {\tilde{h}}_{j} τ} or {B}_{j} = {e}^{- {\tilde{h}}_{j} τ}$$

in one example, wherein \tilde{h}ⱼ is a local Hamiltonian that generates the local unitary operator according to u

$${u}_{j} = {e}^{- i {\tilde{h}}_{j} t} ,$$

and the τ is a time. The time τ may be arbitrary, but preferable it is chosen small, in particular Σⱼ∥hⱼ∥τ<1, or Σⱼ∥hⱼ∥τ<1, respectively. The imaginary time evolution determined by the local Hamiltonian operator hⱼ of the set of local Hamiltonian operators may be Bⱼ=e^{+h}^{ⱼ}^{τ} or Bⱼ=e^{-h}^{ⱼ}^{τ} in one example, wherein τ is the time.

In the following, to simplify notation, e^{±h}^{ⱼ}^{τ} is used for the imaginary time evolution operator independent of the local operator Oⱼ that determines the imaginary time evolution operators. I.e., referring to the above, hⱼ may denote a local Hamiltonian of the set of local Hamiltonians of the description of the system unitary evolution or the generator of the local unitary operator uⱼ, but the invention is not limited to this. In one example where the quantum system comprises a plurality of qubits and the local Hamiltonian hⱼ acts on a number of kⱼ qubits. the imaginary time evolution of the subsystem S; under the imaginary time evolution operator Bⱼ=e^{+h}^{ⱼ}^{τ} or Bⱼ=e^{-h}^{ⱼ}^{τ} may be realized by preparing the auxiliary quantum system ASⱼ associated with the local Hamiltonian operator hⱼ in an appropriate initial auxiliary quantum state, by implementing the unitary

$${U}_{{\hat{B}}_{j}} = ( \begin{matrix}{\hat{B}}_{j} & {( I - {\hat{B}}_{j}^{†} {\hat{B}}_{j} )}^{\frac{1}{2}} \\ {( I - {\hat{B}}_{j}^{†} {\hat{B}}_{j} )}^{\frac{1}{2}} & - {\hat{B}}_{j}\end{matrix} ) or {U}_{{\hat{B}}_{j}} = ( \begin{matrix}{\hat{B}}_{j} & - {( I - {\hat{B}}_{j}^{†} {\hat{B}}_{j} )}^{\frac{1}{2}} \\ {( I - {\hat{B}}_{j}^{†} {\hat{B}}_{j} )}^{\frac{1}{2}} & {\hat{B}}_{j}\end{matrix} ) ,$$

denoting the normalized operator as \hat{B}ⱼ=Bⱼ/∥Bⱼ∥ and wherein ∥⋅∥ is an operator norm, on the subsystem S; and the auxiliary quantum system ASⱼ followed by a measurement of the auxiliary system and an appropriate post-selection in accordance with the measurement outcome. When the quantum system and the auxiliary quantum system are qubit systems, the auxiliary quantum system ASⱼ may be prepared in the computational zero state and the independent auxiliary quantum measurement of the auxiliary quantum system ASⱼ may be a measurement in the computational basis. Then, the imaginary time evolution of the subsystem S; under the imaginary time evolution operator Bⱼ=e^{±h}^{ⱼ}^{τ} may have been achieved when the auxiliary measurement outcome of the auxiliary quantum measurement of the auxiliary quantum system ASⱼ is indicative of the computational zero state. If the auxiliary measurement outcome is different from this state, the execution of the quantum algorithm may be terminated and repeated until the desired measurement outcome is achieved.

Calculating the matrix U_{\hat{B}}_{ⱼ} requires computing the square root of the matrix

$${B}_{j}^{†} {B}_{j}$$

which in turn requires computing and diagonalizing the matrix

$${B}_{j}^{†} {B}_{j} .$$

When the local Hamiltonian hⱼ is k-local, the matrix

$${B}_{j}^{†} {B}_{j}$$

has dimension 2^{k}×2^{k}. Then, computing the square root of the matrix

$${B}_{j}^{†} {B}_{j}$$

may be efficiently implemented, for example, on a classical computer when the support of the local Hamiltonian is small enough, e.g., k=2, 3, 4, 5. Thereby, the exact unitary evolution of the subsystem and its associated auxiliary system may be determined.

In one example where the local Hamiltonian hⱼ acts on kⱼ qubits, the auxiliary quantum system may also comprise kⱼ qubits.

In one example of the embodiment, the imaginary time evolution is very short, so that the imaginary time evolution operator may be linearized as e^{±h}^{ⱼ}^{τ}≈I±τhⱼ+O(τ²). This operator may be implemented by use of the “linear combination of unitaries” (LCU) technique, see A. Childs and N. Wiebe “Hamiltonian Simulation using linear combinations of unitary operations”, arXiv:1202.5822v1, applied to the operator (I±τhⱼ) with suitable normalization as prescribed by the LCU technique. In particular, the imaginary time evolution under each of the local operators e^{±h}^{ⱼ}^{τ} may be achieved by use of an associated auxiliary quantum system that consists of a single qubit and the joint action of the total unitary evolution comprises a controlled application of the local operator hⱼ on its corresponding subsystem controlled by the quantum state of the associated auxiliary quantum system.

In one example of the embodiment, the imaginary time evolution under each of the local operators e^{±h}^{ⱼ}^{τ} may be achieved exactly by an associated auxiliary quantum system that consists of a single qubit and the joint action of the total unitary evolution comprises a controlled application of the local operator hⱼ on its corresponding subsystem controlled by the quantum state of the associated auxiliary quantum system. Each associated auxiliary quantum system is rotated in the Bloch sphere before and after the controlled application. The rotation angle and rotation axis on the Bloch sphere of each associated auxiliary quantum system can be chosen such that the imaginary time evolution under each of the local operators e^{±h}^{ⱼ}^{τ} may be implemented exactly.

In one example of the embodiment, the plurality of quantum algorithms comprises for each of a plurality of points in time an associated quantum algorithm that requires for each local operator of the description of the system unitary evolution in terms of local operators an associated auxiliary quantum system, the quantum measurement comprises for each auxiliary quantum system an independent quantum measurement, and wherein depending on an appropriate post-selection of the associated measurement outcome of each auxiliary quantum measurement the action of the total unitary evolution on each subsystem comprises the imaginary time evolution determined by its corresponding local operator, and wherein the joint unitary evolution further comprises an evolution of the quantum system under the system unitary evolution up to the point in time.

According to the example, the plurality of quantum algorithms comprises for each of a plurality of points in time t_{α}, α=1, . . . , L, t₁<t₂< . . . <t_{L}, an associated quantum algorithm A_{α} that is associated with the local operator Oⱼ of the description of the system unitary evolution in terms of local operator. In particular, each local operator Oⱼ may be a local unitary operator uⱼ, j=1, . . . , N of a sequence or N local unitary operators U_{N}, . . . , u₁ that may be an exact or an approximate decomposition of the system unitary evolution, i.e., U_{sys}=u_{N} · . . . ·u₁ or U_{sys}≈u_{N}⋅ . . . ⋅u₁, or a local Hamiltonian operator hⱼ of a set of local Hamiltonian operators {h₁, . . . , h_{N}}, the sum of which is a Hamiltonian H that generates the system unitary evolution or an approximation thereof, i.e., U_{sys}=e^{itΣ}^{ⱼ}^{h}^{ⱼ}, or U_{sys}≈e^{itE}^{ⱼ}^{h}^{ⱼ}. The associated quantum algorithm A_{α} requires for each of the N local operators an associated auxiliary quantum system ASⱼ, j=1, . . . , N. The execution of each quantum algorithm A, comprises providing the total quantum system that comprises the quantum system prepared in the initial quantum state and the auxiliary quantum systems, each prepared in an appropriate auxiliary quantum state, evolving the total quantum system under an associated total unitary evolution that comprises applying for each of the auxiliary quantum systems ASⱼ that are associated with the respective local operator and the associated subsystem Sⱼ a unitary operator, in particular the unitary operator U_{B}_{ⱼ} defined above, followed by a measurement of the auxiliary quantum system ASⱼ and an appropriated post-selection to thereby obtain an evolution of the subsystem Sⱼ under the imaginary time evolution operator determined by the local operator Oⱼ, and in particular Bⱼ=e^{+h}^{ⱼ}^{τ} or Bⱼ=e^{-h}^{ⱼ}^{τ}.

In particular, the plurality of quantum circuits may be such that for each of a plurality of points in time t_{α}, α=1, . . . , L, t₁<t₂< . . . <t_{L}, there are first and second quantum algorithms

$${A}_{α}^{\pm }$$

that are such that, upon an appropriate post-selection, the action of the total unitary evolution on the quantum system comprises the imaginary time evolution according to the imaginary time evolution operator e^{-h}^{_{N}}^{τ} . . . e^{-h}^{₁}^{τ} for the first quantum algorithm

$${A}_{α}^{-}$$

and e^{+h}^{_{N}}^{τ} . . . e^{+h}^{₁}^{τ} for the second quantum algorithm

$${A}_{α}^{+} .$$

As explained above, each local Hamiltonian hⱼ may be one of the local Hamiltonians of the set of local Hamiltonians or a generator of one of the local unitary operators of the sequence of local unitary operators. Furthermore, each of the first and second quantum algorithms

$${A}_{α}^{\pm }$$

comprises a unitary evolution of the quantum system under the system unitary evolution up to the point t_{α} in time, e^{-iHt}^{_{α}}. The execution of the plurality of first and second quantum algorithms results in a plurality of computational results that allows to determine a time series of the time derivatives of the phase of the overlap at different points in time, e.g.,

$$\frac{d ϕ}{dt} {\vert}_{{t}_{α}} α = 1 , … , L .$$

In particular, the computational results may allow to determine the complex phase φ(t) of the overlap g(t)=<ψ|e^{-iHt}|ψ>=r(t)e^{iφ(t)} by use of the Cauchy-Riemann equations of complex analysis from which it follows that

$$\frac{\partial ϕ ( t )}{\partial t} {\vert}_{{t}_{α}} = \frac{\partial log r ( {t}_{α} - i β )}{\partial β} {\vert}_{β = 0} \approx \frac{1}{2 τ} ( log r ( {t}_{α} - i τ ) - log r ( {t}_{α} + i τ ) ) ,$$

wherein r(t_{α}±iτ)=| [symbol] |e^{-Ht}^{_{α}}e^{±Hτ}|ψ [symbol] |² may be obtained from the measurement outcome of the projective measurement onto the reference quantum state. In one example, the method may further comprise a numerical integration of the time derivatives to obtain the phase.

According to a second aspect of the present invention, there is provided a hybrid quantum-classical computing system, the computing system comprising a classical processor and a quantum processor, wherein the system is configured to:
receive, by the quantum processor, a plurality of quantum algorithms for estimating an overlap of a reference quantum state and an evolved quantum state of a quantum system, the evolved quantum state resulting from an evolution of an initial quantum state of the quantum system under a system unitary evolution having a representation in terms of local operators that act on corresponding local subsystems of the quantum system, wherein each of the quantum algorithms requires at least one dedicated auxiliary quantum system associated with one of the local operators in a one-to-one correspondence;
execute, by the quantum processor, each of the plurality of quantum algorithms to thereby obtain a plurality of computational results indicative of a data series of phase information of the overlap, wherein the execution of each quantum algorithm comprises:
providing a total quantum system including the quantum system prepared in the initial quantum state and the at least one auxiliary quantum system prepared in an initial auxiliary quantum state;
evolving the total quantum system under a total unitary evolution, wherein a joint action of the total unitary evolution on the quantum system and the at least one auxiliary quantum system is limited to each auxiliary quantum system and the corresponding subsystem of its associated local operator and determined by the associated local operator;
applying a projective quantum measurement onto the reference quantum state to the quantum system and applying an auxiliary quantum measurement to the at least one auxiliary quantum system to thereby obtain the computational result;
receive, by the classical processor, the plurality of computational results, and to estimate, by the classical processor, at least a phase of the overlap on the basis of the computational results.

In one example, the classical computer may estimate the complete overlap and not only its phase.

The hybrid quantum classical computing system according to the second aspect of the present invention may be used to carry out the method according to the first aspect of the present invention.

According to a third aspect of the present invention, there is provided a computer program product comprising instructions, which, when the computer program product is executed on a quantum processor, cause the quantum processor to carry out the method according to the first aspect of the present invention. The computer program product according to the third aspect of the present invention may be used in the hybrid quantum-classical computing system according to the second aspect of the present invention.

According to a fourth aspect of the present invention, there is provided a computer-readable storage medium comprising instructions, which, when executed by a quantum processor, cause the quantum processor to carry out the method according to the first aspect of the present invention. In particular, the computer-readable storage medium may be a non-transitory storage medium.

According to a fifth aspect of the present invention, there is provided a data set representing a plurality of computational results obtainable by the method according to any one of claims 1-15. In one example, the data set may comprise for at least one quantum algorithm Aⱼ of the plurality of quantum algorithms a representation of at least one measurement outcome of the projective quantum measurement onto the reference quantum state corresponding to one of a plurality of shots of the quantum algorithm. In certain examples, the data set comprises, in addition, for the at least one quantum algorithm Aⱼ of the plurality of quantum algorithms a representation of at least one measurement outcome of the auxiliary quantum measurement corresponding to one of a plurality of shots of the quantum algorithm. In one example, the data set may comprise for each quantum algorithm Aⱼ of the plurality of quantum algorithms a representation of at least one measurement outcome of the projective quantum measurement onto the reference quantum state corresponding to one of a plurality of shots of the quantum algorithm. In certain examples, the data set comprises, in addition, for each quantum algorithm Aⱼ of the plurality of quantum algorithms a representation of at least one measurement outcome of the auxiliary quantum measurement corresponding to one of a plurality of shots of the quantum algorithm. In certain examples, the data set may comprise for each quantum algorithm Aⱼ of the plurality of quantum algorithms and each shot of a plurality of M>1 shots of the execution of the quantum algorithm a representation of the measurement outcome of the projective quantum measurement onto the reference quantum state. Additionally, the data set may comprise for each shot the measurement outcome of the auxiliary quantum measurement.

In yet another example, the data set comprises for at least one quantum algorithm a representation of an estimator value of an observable derived from the measurement outcome of the projective quantum measurement onto the reference state and/or the measurement outcome of the auxiliary quantum measurement. In one example, the data set comprises for each quantum algorithm a representation of an estimator value of an observable derived from the measurement outcome of the projective quantum measurement onto the reference state and/or the measurement outcome of the auxiliary quantum measurement.

In the following, the invention will be further described by way of example with reference to the drawings in which

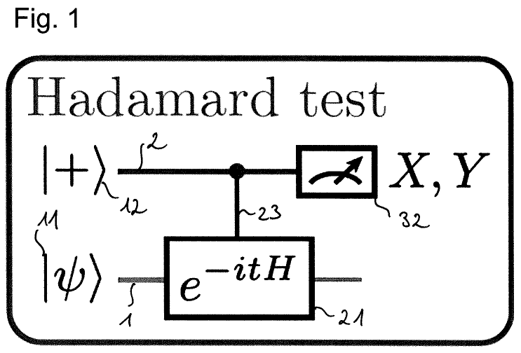

FIG. 1 is a representation of a quantum algorithm for the Hadamard test known in the art;

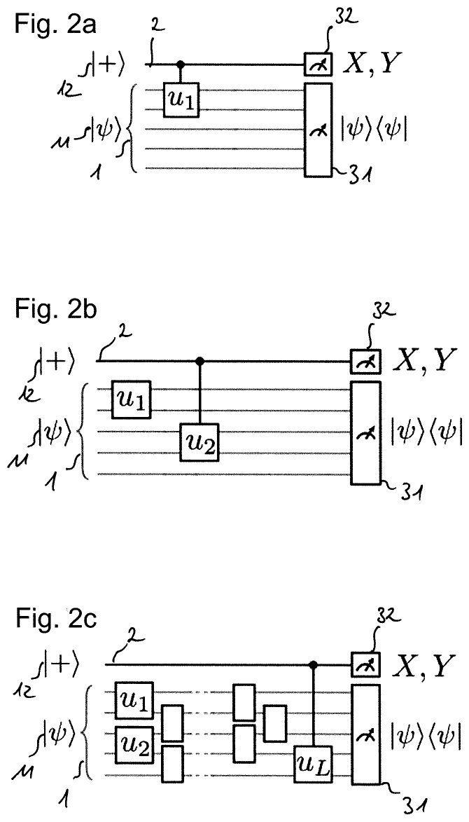

FIGS. 2a-2c are representations of quantum algorithms of a first embodiment of the method according to the first aspect of the present invention;

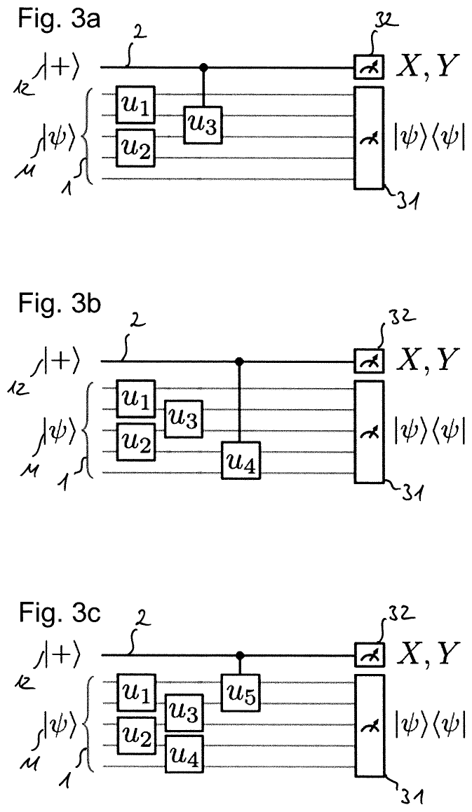

FIGS. 3a-3c are representations of further quantum algorithms of a first example of the first embodiment of the method according to the first aspect of the present invention;

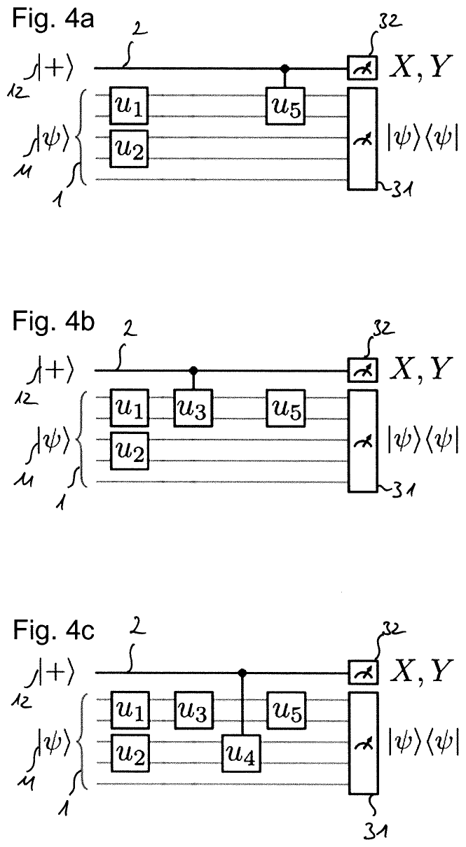

FIGS. 4a-4c are representations of further quantum algorithms of a second example of the method according to the first aspect of the present invention;

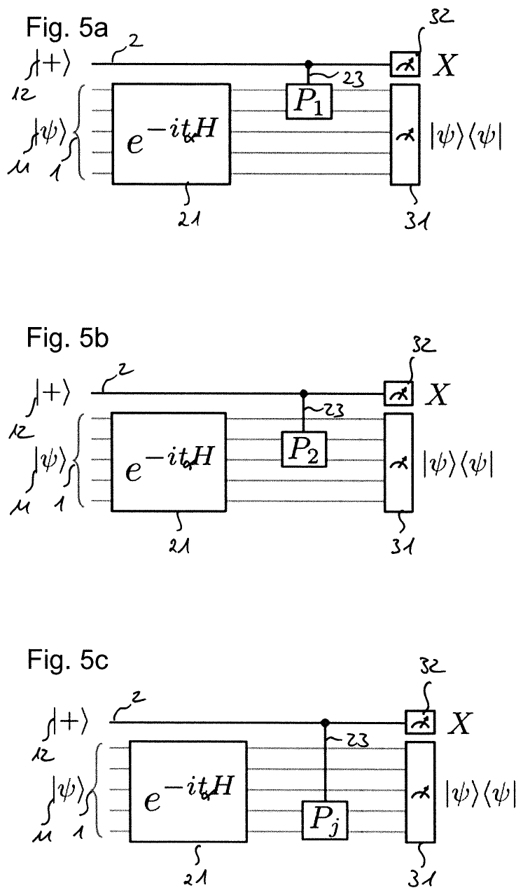

FIGS. 5a-5b are representations of quantum algorithms of a second embodiment of the method according to the first aspect of the present invention;

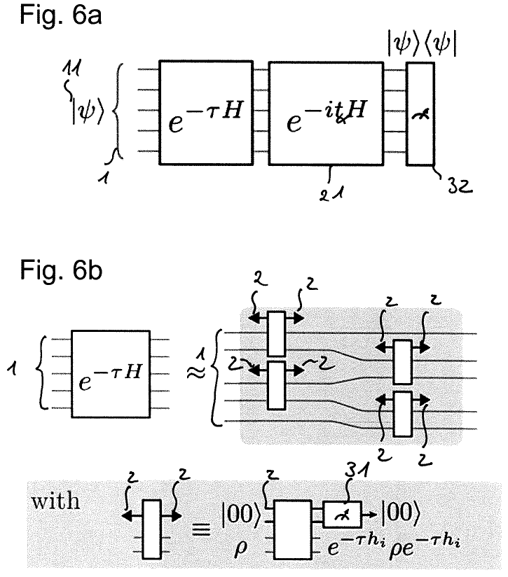

FIG. 6a is a schematic representation of a quantum algorithm of a third embodiment of the method according to the first aspect of the present invention where the auxiliary quantum systems are not shown;

FIG. 6b schematically represents the implementation of the imaginary time evolution part of FIG. 6a by use of auxiliary quantum system;

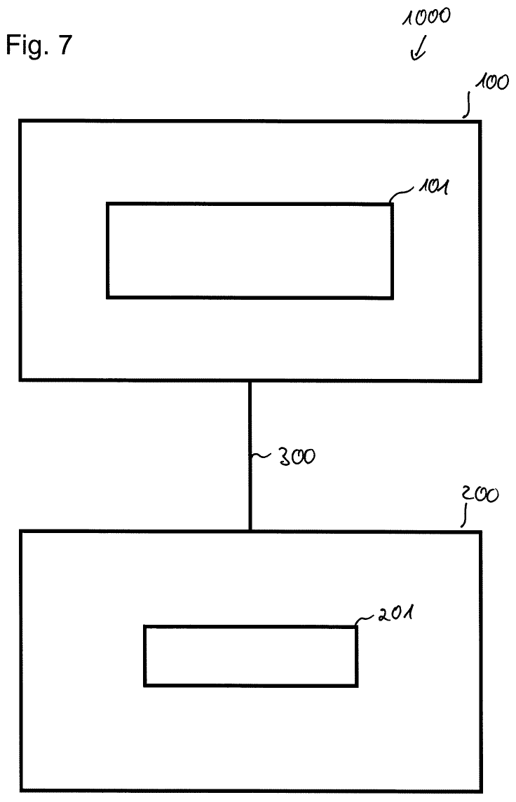

FIG. 7 schematically represents a hybrid quantum classical computing system according to the second aspect of the present invention.

In the following, embodiments and examples of the methods and devices for estimating an overlap [symbol] ψ_{ref}ψₑᵥₒₗᵥ [symbol] of a reference quantum state |ψ_{ref} [symbol] and an evolved quantum state |ψₑᵥₒₗᵥ [symbol] of a quantum system according to the present invention are presented exemplarily for the case of qubits. To be more precise, in the following examples the quantum system is a system of a plurality of K>1 qubits and the auxiliary quantum system is a qubit system with at least one qubit. However, the invention is not limited to qubits, and it is clear for those skilled in the art how the embodiments and examples work for other quantum mechanical systems. The evolved quantum state |ψ_{ref} [symbol] results from an evolution of an initial quantum state |ψᵢₙᵢ [symbol] of the quantum system under a system unitary evolution U_{sys}, |ωₑᵥₒₗᵥ [symbol] =U_{sys}|ψᵢₙᵢ [symbol] . In one example, U_{sys}=e^{-iHt}, wherein H is a Hamiltonian generating the unitary evolution and t is the time. In some examples, t=1, but the invention is not limited to this. For ease of representation, the embodiments and examples are presented for the case that the reference quantum state |ψ_{ref} [symbol] is identical to the initial quantum state |ψᵢₙᵢ [symbol] , and the notation |ψᵢₙᵢ [symbol] =|ψ_{ref} [symbol] =|ψ [symbol] is used in the following. For those skilled in the art, the generalization to the case where the reference quantum state is different from the initial quantum state is clear. The overlap g= [symbol] ψ|U_{sys}|ψ [symbol] =re^{iφ} is a complex number and may be expressed in terms of an amplitude r and a phase 0≤φ<2π.

FIG. 1 is a representation of a quantum algorithm of the known Hadamard test for estimating the overlap. A quantum system 1 is prepared in an initial quantum state |ψ [symbol] (reference sign 11). The Hadamard test requires a single auxiliary quantum system 2 which is a single qubit prepared in an initial auxiliary quantum state

$$\vert + 〉 = \frac{1}{\sqrt{2}} ( \vert 0 〉 + \vert 1 〉 )$$

(reference sign 12). The total quantum system of the quantum system 1 and the auxiliary quantum system 2 evolves under a total unitary evolution that comprises a controlled application 23 of the system unitary 21 to the quantum system 1 controlled by the quantum state 12 of the auxiliary quantum system 2. That is, the total quantum state of the quantum system 1 and the auxiliary quantum system 2 prepared in the total initial quantum state |ψₜₒₜ [symbol] =|+ [symbol] |ψ [symbol] evolves as

$$\vert {ψ}_{tot} 〉 \to \frac{1}{\sqrt{2}} \text{(\textbar} 0 〉 \vert ψ 〉 + \vert 1 〉 {U}_{sys} \vert ψ 〉 ) .$$

Finally, an auxiliary quantum measurement 32 that measures the Pauli-X and Pauli-Y operators is applied to the auxiliary quantum system 2 and the overlap g may be determined on the basis of the measurement outcomes of these measurements.

As it is apparent from FIG. 1, the standard Hadamard test requires a global control of the quantum system 1 by the single auxiliary quantum system 2.

Below, embodiments of the method according to the first aspect of the present invention are described with reference to FIGS. 2-6b. Each embodiment of the method comprises executing a plurality of quantum algorithms to thereby obtain a plurality of computational results indicative of a data series of phase information of the overlap. Each quantum algorithm may be executed by a quantum processor in one example.

In the following, a first embodiment of the method according to the first aspect of the present invention is described with reference to FIGS. 2a-4c. The first embodiment of the method is particularly well-suited for digital quantum processors that allow for an application of a sequence of quantum gates. In the first embodiment, the description of the system unitary evolution U_{sys} comprises a sequence of local unitary operators according to u_{N}_{_{gates}}·_{N}_{_{gates}}₋₁· . . . ·u₂·u₁, wherein each uⱼ, j=1, . . . , N_{gates} is a local unitary operator and N_{gates} is the number of local quantum operations. The local unitary operator u; acts on a corresponding subsystem Sⱼ of k qubits, preferably at most k=2 qubits. In particular, the local operators may be understood as quantum gates, for example, single or two-qubit gates. The description of the system unitary evolution in terms of the sequence of local unitary operators may correspond to an exact decomposition of the system unitary evolution, i.e., U_{sys}=u_{N}_{_{gates}}·u_{N}_{_{gates}}⁻¹· . . . ·u₂·u₁ or it may correspond to an approximation of U_{sys}, i.e., U_{sys}≈u_{N}_{_{gates}}·u_{N}_{_{gates}}₋₁· . . . ·u₂·u₁.

The method according to the first embodiment comprises executing a quantum algorithm Aⱼ for each local operator uⱼ of the N_{gates} local operators of the description of the system unitary evolution. The quantum algorithms A₁, . . . A_{N}_{_{gates}} form a series of quantum algorithms from an initial quantum algorithm A₁ to a final quantum algorithm A_{N}_{_{gates}}. Each quantum algorithm Aⱼ requires a single auxiliary quantum system associated with a local operator uⱼ. In the embodiment, the single auxiliary quantum system is a single qubit. The execution of each quantum algorithm (see FIGS. 2a-4c) comprises preparing the quantum system 1 in the initial quantum state |ψ [symbol] (reference 11) and preparing the single auxiliary quantum system which is a single qubit in the initial auxiliary quantum state

$$\vert + 〉 = \frac{1}{\sqrt{2}} ( \vert 0 〉 + \vert 1 〉 )$$

(reference sign 12). Then, the total quantum system, including the quantum system 1 and the auxiliary quantum system 2, is evolved under a total unitary evolution followed by applying a projective quantum measurement 31 onto the reference quantum state |ψ [symbol] [symbol] ψ| to the quantum system 1 and applying an auxiliary quantum measurement 3 single auxiliary quantum system to thereby obtain a computational result. In particular, the auxiliary quantum measurement is a measurement of the Pauli-X and Pauli-Y operators.

The series of quantum algorithms A₁, . . . , A_{N}_{_{gates}} comprises for each of the local operators uⱼ an associated quantum algorithm Aⱼ. The initial quantum algorithm A₁ of the series of quantum algorithms A₁, . . . , A_{N}_{_{gates}} is shown in FIG. 2a and comprises an initial total unitary evolution that consists of the controlled application of the first local unitary operator u₁ of the description of the system unitary evolution to its corresponding subsystem S₁ controlled by the quantum state of the auxiliary quantum system 2. That is, the local operator u₁ acts on its corresponding subsystem S₁ controlled by the quantum state |+ [symbol] of the auxiliary quantum system.

The series of quantum algorithms A₁, . . . , A_{N}_{_{gates}} of the first embodiment is such that a subsequent total unitary evolution of a subsequent quantum algorithm Aⱼ₊₁ of the series of quantum algorithms A₁, . . . , A_{N}_{_{gates}} differs from a preceding total unitary evolution of a preceding quantum algorithm Aⱼ of the series of quantum algorithms A₁, . . . , A_{N}_{_{gates}} in that a control is removed from a previously controlled local unitary operator uⱼ associated with the preceding quantum algorithm Aⱼ and a controlled application of a local unitary operator uⱼ₊₁ associated with the subsequent quantum algorithm Aⱼ₊₁ to its corresponding subsystem Sⱼ₊₁ is added at a position in accordance with the sequence of local unitary operators.

Possible quantum algorithms of the series of quantum algorithms A₁, . . . , A_{N}_{_{gates}} of the first embodiment are explained with reference to FIGS. 2b-3c. FIG. 2b is an example of a second quantum algorithm A₂ of the series of quantum algorithms. The second quantum algorithm A₂ is associated with the second local unitary operator u₂ of the sequence of local unitary operators. As one may take from FIG. 2b, the local control of the first unitary operator u₁ is removed and the local unitary operator u₁ is applied to its corresponding subsystem S₁ without any control. Furthermore, a controlled application of the second local unitary operator u₂ associated with the second quantum algorithm A₂ to its corresponding subsystem S₂ is added at its position in accordance with the sequence of local unitary operators.

FIGS. 3a-3c are representations of further quantum algorithms of the sequence of quantum algorithms A₁, . . . , A_{N}_{_{gates}} of a first example of the first embodiment of the method according to the first aspect of the present invention wherein the quantum algorithm Aⱼ is associated with the local unitary operator uⱼ, j=3, . . . , N_{gates}, and the initial quantum algorithm A₁ and the second quantum algorithm A₂ are as in FIGS. 2a and 2b, respectively. FIG. 3a depicts a third quantum algorithm A₃ associated with the third local operator u₃ of the sequence of local unitary operators. Compared to the second quantum algorithm A₂ shown in FIG. 2b, the control of the second local unitary operator u₂ is removed, and a controlled application of the third local unitary operator u₃ to its corresponding subsystem S₃ is added at its position in accordance with the sequence of local unitary operators. FIG. 3b depicts a fourth quantum algorithm A₄ of the series of quantum algorithms A₁, . . . , A_{N}_{_{gates}} that is associated with the fourth local unitary operator u₄ of the series of local unitary operators. Compared to the third quantum algorithm A₃ shown in FIG. 3a, the control of the third local unitary operator u₃ is removed, and a controlled application of the fourth local unitary operator u₄ to its corresponding subsystem S₄ is added at its position in accordance with the sequence of local unitary operators. FIG. 3c depicts a fifth quantum algorithm A₅ of the series of quantum algorithms A₁, . . . , A_{N}_{_{gates}} that is associated with the fifth local unitary operator u₅ of the series of local unitary operators. Compared to the fourth quantum algorithm A₄ shown in FIG. 3b, the control of the fourth local unitary operator u₄ is removed, and a controlled application of the fifth local unitary operator u₅ to its corresponding subsystem S₅ is added at its position in accordance with the sequence of local unitary operators.

FIG. 2c shows the L-th quantum algorithm A_{L} associated with the L-th local unitary operator u_{L}. As one may take from FIG. 2c, the local unitary operators u₁, . . . , u_{L-1} are applied to their corresponding subsystems S₁, . . . , S_{L-1} at their positions in accordance with the sequence of local unitary operators followed by a controlled application of the local unitary u_{L} to its corresponding subsystem S_{L-1} controlled by the quantum state of the auxiliary quantum system.

By executing the L-th quantum algorithm (see FIG. 2c), a computational result is obtained which is indicative of the expectation values

$$〈 {σ}_{x} ⊗ \vert ψ 〉 〈 ψ \vert 〉 = Re [ {g}_{L} {g}_{L - 1}^{*} ]$$

for the Pauli-X measurement and

$$〈 {σ}_{y} ⊗ \vert ψ 〉 〈 ψ \vert 〉 = Im [ {g}_{L} {g}_{L - 1}^{*} ]$$

for the Pauli-Y measurement, wherein g_{L}= [symbol] u_{L}·u_{L-1}· . . . ·u₂·u₁)|ψ [symbol] may be understood as the overlap after the L-th gate. In one example, the computational results may comprise for each quantum algorithm estimator values of the expectation values [symbol] σₓ⊗|ψ [symbol] and [symbol] ψ| [symbol] and [symbol] σ_{y}⊗|ψ [symbol] [symbol] ψ| [symbol] , The estimator values may obtained by averaging over the measurement outcomes of the M shots of the quantum algorithm in one example. In one example, the computational results may comprise for each quantum algorithm the measurements outcomes of the M shots that allow to derive estimator values of (σₓ⊗|ψ [symbol] [symbol] ψ| [symbol] and [symbol] σ_{y}⊗|ψ [symbol] [symbol] ψ| [symbol] . The overlap of the reference quantum state and the evolved quantum state may then be obtained from the following recursive formula:

$$〈 ψ \vert {U}_{sys} \vert ψ 〉 = {g}_{{N}_{gates}} = \frac{{g}_{{N}_{gates}} {g}_{{N}_{{gates}^{- 1}}}^{*}}{{g}_{{N}_{{gates}^{- 1}}}^{*} {g}_{{N}_{{gates}^{- 2}}}} , \frac{{g}_{{N}_{{gates}^{- 2}}} {g}_{{N}_{{gates}^{- 3}}}^{*}}{{g}_{{N}_{{gates}^{- 3}}}^{*} {g}_{{N}_{{gates}^{- 4}}}} , … , \frac{{g}_{2} {g}_{1}^{*}}{{g}_{1}^{*}} .$$

Certain instances of the embodiment may comprise a calculation of the phase of the overlap via the recursive formula.

Considering the phase information (φ_{L}−φ_{L-1}) of the quantity

$${g}_{L} {g}_{L - 1}^{*} = {r}_{L} {r}_{L - 1} {e}^{i ( {ϕ}_{L} - {ϕ}_{L - 1} )} ,$$

the formula also applies to only the phase information: φ_{N}_{_{gates}}=(φ_{N}_{_{gates}}−φ_{N}_{_{gates}}₋₁)−(φ_{N}_{_{gates}}₋₂−φ_{N}_{_{gates}}₋₁)+(φ_{N}_{_{gates}}₋₂−φ_{N}_{_{gates}}₋₃)−(φ_{N}_{_{gates}}₋₄−φ_{N}_{_{gates}}₋₃)+ . . . +(φ₂−φ₁)−(0−φ₁). The absolute values r_{L} can be measured separately and combined with the phase information obtained through the formula. To obtain the absolute value of a Loschmidt echo r=| [symbol] ψ|U_{sys}|ψ [symbol] |, one prepares the system in the initial state |ψ [symbol] . applies by the action of the unitary operator U_{sys}, and measures the system in a basis containing the initial state. Dividing the number of successful projections onto the initial state is an estimator for the absolute value squared: r²= [symbol] ψ|U_{sys}|ψ [symbol] [symbol] ψ|U^{†}_{sys}|ψ [symbol] . Measuring the absolute value of the Loschmidt echo is well-known in the art of quantum computation.

Instead of the quantum algorithms shown in FIG. 3a-3c, the series of quantum algorithms A₁, . . . , A_{N}_{_{gates}} of second example of the first embodiment may comprise the quantum algorithms shown in FIG. 4a-4c. In the second example, the third quantum algorithm A₃ (see FIG. 4a) is associated with the fifth local unitary operator u₅ of the sequence of local unitary operators, the fourth quantum algorithm A₄ (see FIG. 4b) is associated with the third local unitary operator u₃ of the sequence of local unitary operators and the fifth quantum algorithm A₅ (see FIG. 4c) is associated with the fourth local unitary operator u₄ of the sequence of local unitary operators.

FIG. 4a depicts the third quantum algorithm A₃ associated with the fifth local operator u₅ of the sequence of local unitary operators. Compared to the second quantum algorithm A₂ shown in FIG. 2b, the control of the second local unitary operator u₂ is removed, and a controlled application of the fifth local unitary operator u₅ to its corresponding subsystem S₅ is added at its position in accordance with the sequence of local unitary operators. FIG. 4b depicts the fourth quantum algorithm A₄ of the series of quantum algorithms A₁, . . . , A_{N}_{_{gates}} that is associated with the third local unitary operator u₃ of the series of local unitary operators. Compared to the third quantum algorithm A₃ shown in FIG. 4a, the control of the fifth local unitary operator u₅ is removed, and a controlled application of the third local unitary operator u₃ to its corresponding subsystem S₃ is added at its position in accordance with the sequence of local unitary operators. FIG. 4c depicts a fifth quantum algorithm A₄ of the series of quantum algorithms A₁, . . . A_{N}_{_{gates}} that is associated with the fourth local unitary operator u₄ of the series of local unitary operators. Compared to the fourth quantum algorithm A₄ shown in FIG. 4b, the control of the third local unitary operator u₃ is removed, and a controlled application of the fourth local unitary operator u₄ to its corresponding subsystem S₄ is added at its position in accordance with the sequence of local unitary operators. A similar recursive formula as the one above for calculating the overlap may be obtained for this second example, and the overlap may be calculated on the basis of the computational results of the execution of the series of quantum algorithms.

As one may take from the second example of the first embodiment, the quantum algorithms may be optimized by selecting the order of the controlled application of the local unitary operators to thereby reduce the circuit depth. In particular, when the initial quantum state 11 is a product state, one may consider a decomposition of the quantum system 1 into two disjoint systems which are first evolved independently from each other under local unitary operators of the sequence of local unitary operators that only have support on one of the two systems before a local controlled operation that acts on both of the disjoint systems is applied.

In the following, a second embodiment of the method according to the first aspect of the present invention is explained with reference to FIGS. 5a-5c. The method comprises executing a plurality of quantum algorithms to thereby obtain a plurality of computational results indicative of a data series of phase information of the overlap. Each quantum algorithm requires a single auxiliary quantum system associated with one local Hamiltonian operator hⱼ of a set of local Hamiltonian operators {h₁, . . . , h_{N}_{_{H}}} of a representation of the system unitary evolution in terms of local operators. The local Hamiltonian operator hⱼ, j=1, . . . , N_{H} acts on a corresponding subsystem Sⱼ of k qubits, preferably at most k=2 qubits. The sum of the local Hamiltonians may generate the system unitary evolution or an approximation thereof, i.e., U_{sys}=e^{-iHt} or U_{sys}≈e^{-iHt}, wherein

$$H = {\sum }_{j = 1}^{{N}_{H}} {h}_{j}$$

In particular, each local Hamiltonians is proportional to a Pauli string in the embodiment, i.e., hⱼ=λⱼ\hat{P}ⱼ, wherein λⱼ is a scalar and

$${\hat{P}}_{j} = {⊗}_{q = 1}^{{N}_{H}} {P}_{q} ,$$

wherein P_{q}∈{l_{q}, X_{q}, Y_{q}, Z_{q}} is either the Pauli-X, -Y, or -Z operator or the identity operator acting on the qubit q, and only k of the N_{H} operators are different from the identity. I.e., \hat{P}ⱼ is a Pauli string acting on at most k qubits of the K qubits of the quantum system. The auxiliary quantum system is one single qubit in the embodiment.

The plurality of quantum algorithms comprises for each local Hamiltonian hⱼ and each of a plurality of points in time t_{α}, α=1, . . . , T, wherein t₁< . . . <t_{T}. an associated quantum algorithm A_{j,α}. Executing the quantum algorithm A_{j,α} comprises providing a total quantum system including the quantum system 1 prepared in the initial quantum state |ψ [symbol] 14 (reference sign 11) and the one auxiliary quantum system 2 which is a single qubit prepared in the initial auxiliary quantum state |+ [symbol] (reference sign 12). Then, the total quantum system 3 is evolved under a total unitary evolution associated with the quantum algorithm A_{j,α} and a projective quantum measurement |ψ [symbol] [symbol] ψ| (reference sign 31) onto the reference quantum state is applied to the quantum system 1 and an auxiliary quantum measurement 32 is applied to the auxiliary quantum system 2 to measure the Pauli-X operator. Thereby, the computational result of the quantum algorithm is obtained.

The total unitary evolution of the quantum algorithm A_{j,α} associated with the local Hamiltonian hⱼ=λⱼPⱼ and the point in time t_{α} evolves the quantum system 1 under the system unitary evolution 21 up to the point in time t_{α}, that is, e^{-Ht}^{_{α}}, followed by the controlled application 23 of the local Pauli string \hat{P}ⱼ of the local Hamiltonian to its corresponding subsystem Sⱼ controlled by the quantum state of the auxiliary quantum system 2. For each quantum algorithm, the computational result obtained from the execution of the quantum algorithm is indicative of

$$〈 {σ}_{x} ⊗ \vert ψ 〉 〈 ψ \vert 〉 = \frac{1}{2} 〈 ψ ( {t}_{α} ) \vert \{ {\hat{P}}_{j} , \vert ψ 〉 〈 ψ \vert \} \vert ψ ( {t}_{α} ) 〉 = {a}_{j} ( {t}_{α} ) .$$

In one example, the computational results may comprise for each quantum algorithm an estimator value of the expectation value [symbol] σₓ⊗|ψ [symbol] [symbol] ψ| [symbol] . In one example, the estimator value may be obtained by averaging over the measurement outcomes of the quantum algorithm. In one example, the computational result may comprise for each quantum algorithm the measurements outcomes (i.e., the measurement outcome of the projective quantum measurement onto the reference quantum state and the auxiliary quantum measurement) of the M shots that allow to derive an estimator value of [symbol] σₓ⊗|ψ [symbol] [symbol] ψ| [symbol] . From the general formula for the time derivative of the overlap g(t)= [symbol] ψ|e^{-iHt}|ψ [symbol] =r(t)e^{iφ(t)}, it is straightforward to see that the time derivative of the phase φ(t) of the overlap at the time

$${t}_{{α}^{′}} \frac{d ϕ ( t )}{dt} {\vert}_{t = {t}_{{α}^{′}}}$$

for the embodiment is a linear combination of the coefficients aⱼ(t_{α}) associated with the time

$${t}_{{α}^{′}} \frac{d ϕ ( t )}{dt} {\vert}_{t = {t}_{α}} = - \frac{1}{2 {r ( t )}^{2}} {\sum }_{j = 1}^{{N}_{H}} {λ}_{j} {a}_{j} ( {t}_{α} ) .$$

Then, the phase of the overlap may be obtained by a numerical integration in certain examples. The determination of the amplitude r(t) is well-known in the art of quantum computation: one may prepare the system in the initial state |ψ [symbol] , apply by the action of the system unitary operator U_{sys}, and measure the system in a basis containing the initial state. Dividing the number of successful projections onto the initial state is an estimator for the absolute value squared: r²= [symbol] ψ|U_{sys}|ψ [symbol] [symbol] ψ|U^{†}_{sys}|ψ [symbol] . The determination of the amplitude does not require controlled operations. Certain examples of the embodiment comprise determining the amplitude r(t).

The method according to the second embodiment of the method according to the first aspect of the present Invention may also be implemented on a hybrid analogue-digital quantum processor that allows to implement the unitary evolution of the quantum system under the system unitary up to the point in time t_{α} in an analogous way.

In the following, a third embodiment of the method according to the first aspect of the present invention is described with reference to FIGS. 6a and 6b. The description of the system unitary evolution in terms of local operators Oⱼ comprises a sequence of local unitary operators u_{N}· . . . ·u₁ wherein each local unitary operator uⱼ acts only on the corresponding subsystem Sⱼ of the quantum system or a sequence of the local Hamiltonians {h₁, . . . , h_{N}}, wherein each local Hamiltonian hⱼ acts only on the corresponding subsystem Sⱼ of the quantum system. In the first case, the sequence of local unitary operators may correspond to an exact decomposition of the system unitary evolution or an approximation thereof, i.e., U_{sys}=u_{N}· . . . ·u₁ or U_{sys}≈u_{N}· . . . ·u₁. In the latter case, the system unitary evolution or an approximation thereof may be generated by a Hamiltonian that is a sum of the local Hamiltonians, i.e., U_{sys}=e^{-iHt}, or, U_{sys}≈e^{-iHt}, wherein

$$H = {\sum }_{j = 1}^{N} {h}_{j} .$$

I.e., each of the local operators Oⱼ of the description of the system unitary evolution is a local Hamiltonian operator hⱼ or a local unitary operator uⱼ generated by a local Hamiltonian \tilde{h}ⱼ according to

$${e}^{- i {\tilde{h}}_{j} t} .$$

The plurality of quantum algorithms of the third embodiment comprises for each of a plurality of points in time t_{α} first and second associated quantum algorithm

$${A}_{α}^{\pm }$$

hat both require an auxiliary quantum system for each of the local operators Oⱼ of the description of the system unitary operator. Depending on an appropriate post-selection of the auxiliary measurement outcomes, the total unitary evolution of the first and second quantum algorithms comprises an imaginary time evolution e^{+Hτ}, respectively e^{-Hτ}, on the quantum system. The imaginary time evolution is implemented by use of the auxiliary quantum systems, as every non-unitary operation on a system can be implemented as a unitary operation on an extended system. τ is a very small time. In particular, as τ is a very small time, the imaginary time evolution operators e^{+Hτ} and e^{-Hτ} are approximated by the sequences e^{-h}^{_{N}}^{τ}e^{+h}^{_{N-1}}^{τ} . . . e^{+h}^{₂}^{τ}e^{-h}^{₁}^{τ} and e^{-h}^{_{N}}^{τ}e^{-h}^{_{N-1}}^{τ} . . . e^{-h}^{₂}^{τ}e^{-h}^{₁}^{τ}, or

$${e}^{+ {\tilde{h}}_{N} τ} {e}^{+ {\tilde{h}}_{N - 1} τ} … {e}^{+ {\tilde{h}}_{2} τ} {e}^{+ {\tilde{h}}_{1} τ}$$

$$and$$

$${e}^{- {\tilde{h}}_{N} τ} {e}^{- {\tilde{h}}_{N - 1} τ} … {e}^{- {\tilde{h}}_{2} τ} {e}^{- {\tilde{h}}_{1} τ}$$

respectively. Each of the first and second quantum algorithm

$${A}_{α}^{\pm }$$

further comprises a unitary evolution of the quantum system 1 under the system unitary up to the point in time t_{α}.

The execution of each quantum algorithm

$${A}_{α}^{\pm }$$

comprises providing a total system including the quantum system 1 prepared in the initial quantum state 11 and each auxiliary quantum system 2 prepared in a predetermined initial quantum state. In the example shown in FIG. 6b, each auxiliary quantum system 2 comprises two qubits prepared in the state 100). Then the joint action of the total unitary evolution on the quantum system 1 and the plurality of auxiliary quantum systems 2 is limited to each auxiliary quantum system 2 and the corresponding subsystem Sⱼ of its associated local operator hⱼ and is such that depending on an appropriate post selection of the measurement outcome of an auxiliary quantum measurement 31 applied to the associated auxiliary quantum system, the subsystem Sⱼ of the quantum system has evolved under an imaginary time evolution with the evolution operator

$${e}^{\pm {h}_{j} τ}$$

$$or$$

$${e}^{\pm {\tilde{h}}_{j} τ} .$$

In the general part of the description it is described how to construct a unitary operation U_{B}_{ⱼ} on the auxiliary quantum system and the corresponding subsystem Sⱼ so as to obtain an imaginary time evolution of the subsystem Sⱼ under the imaginary time evolution operator e^{±h}^{ⱼ}^{τ} or

$${e}^{\pm {\tilde{h}}_{j} τ}$$

depending on an appropriate post-selection of the measurement outcome of the auxiliary quantum system. Alternatively, the imaginary time evolution under each of the local operators e^{±h}^{ⱼ}^{τ} or

$${e}^{\pm {\tilde{h}}_{j} τ}$$

may be achieved by use of an associated auxiliary quantum system that consists of a single qubit and the joint action of the total unitary evolution comprises a controlled application of the local operator hᵢ or \tilde{h}ⱼ on its corresponding subsystem controlled by the quantum state of the associated auxiliary quantum system (see also general part of the description).

When all auxiliary quantum systems 2 are measured, the imaginary time evolution e^{+Hτ}, respectively e^{-Hτ}, of the quantum system may be achieved depending on an appropriate post-selection. Otherwise, the quantum algorithm is stopped and its run is repeated. In one example, the auxiliary quantum measurement is a projective measurement onto the computational basis. Examples for implementing the imaginary time evolution operator are presented below.

The method further comprises applying a projective quantum measurement 32 onto the reference quantum state |ψ [symbol] [symbol] ψ| to the quantum system 1. The computational results obtained with this projective measurement may comprise for each quantum algorithm, e.g., the measurement outcome of the projective quantum measurement for every shot of the quantum algorithm or an estimator value of [symbol] ψ|e^{-iHt}^{_{α}}e^{±Hτ}|ψ [symbol] obtained from the plurality of shots. These computational results allow to determine the complex phase φ(t) of the overlap g(t)= [symbol] ψ|e^{-iHt}ψ [symbol] =r(t)e^{iφ(t)} by use of the Cauchy-Riemann equations of complex analysis from which it follow

$$that \frac{\partial ϕ ( t )}{\partial t} {\vert}_{{t}_{α}} = \frac{\partial log r ( {t}_{α} - i β )}{\partial β} {\vert}_{β = 0} \approx \frac{1}{2 τ} ( log r ( {t}_{α} - i τ ) - log r ( {t}_{α} + i τ ) ) ,$$

wherein r(t_{α}±iτ)=| [symbol] ψ|e^{-iHt}^{_{α}}e^{±Hτ}|ψ [symbol] |² is obtained from the measurement outcome of the projective measurement onto the reference quantum state. Certain examples of the embodiment comprise the computation of the complex phase from a numerical integration, e.g., by a classical computer.

FIG. 7 is a schematic representation of a hybrid quantum-classical computing system 1000 according to the second aspect of the present Invention. The hybrid quantum-classical computing system 1000 comprises a quantum processor 100 and a classical computer 200 with a classical processor 201 connected via a network 300. The quantum processor 100 is configured to receive. e.g., via the network 300, a plurality of quantum algorithms for estimating an overlap [symbol] ψ_{ref}|ψₑᵥₒₗᵥ [symbol] of a reference quantum state |ψ_{ref} [symbol] and an evolved quantum state |ψₑᵥₒₗᵥ [symbol] of a quantum system. The evolved quantum state results from an evolution of an initial quantum state |ψᵢₙᵢ [symbol] of the quantum system under a system unitary evolution U_{sys}=e^{-iHt}, having a representation in terms of local operators that act on corresponding local subsystems of the quantum system. Each of the quantum algorithms requires at least one dedicated auxiliary quantum system associated with one of the local operators in a one-to-one correspondence. The plurality of quantum algorithms may be, e.g., the quantum algorithms of the first to third embodiment explained above with reference to FIGS. 2a-6b. In one example, the quantum system is a qubit system.

The quantum processor 100 is configured to execute each of the plurality of quantum algorithms to thereby obtain a plurality of computational results indicative of a data series of phase information of the overlap. The execution of each quantum algorithm comprises providing, by the quantum processor 100. a total quantum system 101 including the quantum system prepared in the initial quantum state and the at least one auxiliary quantum system prepared in an initial auxiliary quantum state. Then, the quantum processor 100 evolves the total quantum system 101 under a total unitary evolution, wherein a joint action of the total unitary evolution on the quantum system and the at least one auxiliary quantum system is limited to each auxiliary quantum system and the corresponding subsystem of its associated local operator and determined by the associated local operator, and applies a projective quantum measurement onto the reference quantum state to the quantum system and applies an auxiliary quantum measurement to the at least one auxiliary quantum system to thereby obtain the computational result.

The quantum processor 100 is configured to provide the computational results to the classical computer 200, e.g., via the network 300. The classical computer is configured to receive the plurality of computation results, and to estimate, at least a phase of the overlap on the basis of the computational results.

1. A method for estimating an overlap of a reference quantum state and an evolved quantum state of a quantum system, the evolved quantum state resulting from an evolution of an initial quantum state of the quantum system under a system unitary evolution having a description in terms of local operators that act on corresponding local subsystems of the quantum system, characterized in that the method comprises:
executing a plurality of quantum algorithms to thereby obtain a plurality of computational results indicative of a data series of phase information of the overlap, wherein each of the quantum algorithms requires at least one dedicated auxiliary quantum system associated with one of the local operators in a one-to-one correspondence and the execution of the quantum algorithm comprises:
providing a total quantum system including the quantum system prepared in the initial quantum state and the at least one auxiliary quantum system prepared in an initial auxiliary quantum state;
evolving the total quantum system under a total unitary evolution, wherein a joint action of the total unitary evolution on the quantum system and the at least one auxiliary quantum system is limited to each auxiliary quantum system and the corresponding subsystem of its associated local operator and is determined by the associated local operator;
applying a projective quantum measurement onto the reference quantum state to the quantum system and applying an auxiliary quantum measurement to the at least one auxiliary quantum system to thereby obtain the computational result.

2. The method according to claim 1, wherein the plurality of quantum algorithms comprises for at least one local operator of the description a quantum algorithm that requires a single auxiliary quantum system associated with the one local operator.

3. The method according to claim 1, wherein at least one quantum algorithm requires for each local operator of the description an associated auxiliary quantum system.

4. The method according to claim 1, wherein the total unitary evolution of at least one quantum algorithm further comprises an evolution of the quantum system under the system unitary evolution up to a specific point in time.

5. The method according to claim 1, wherein the description of the system unitary evolution comprises a sequence of local unitary operators or a set of local Hamiltonian operators.

6. The method according to claim 1, wherein for at least one quantum algorithm the joint action of the total unitary evolution on at least one of the auxiliary quantum systems and the corresponding subsystem of its associated local operator comprises a controlled application of the associated local operator to the subsystem controlled by a quantum state of the auxiliary quantum system.

7. The method according to claim 1, wherein the quantum system and/or the at least one auxiliary quantum systems are qudit systems, and in particular qubit systems.

8. The method according to claim 7, wherein each auxiliary quantum system is a qudit, and in particular a qubit.

9. The method according to claim 1, wherein the initial auxiliary quantum state is a separable quantum state.

10. The method according to claim 1, wherein the method further comprises estimating at least a phase of the overlap on the basis of the computational results.

11. The method according to claim 1, wherein the plurality of computational results is indicative of a data series of a time derivative of a phase of the overlap at different points in time.

12. The method according to claim 1, wherein the description of the system unitary evolution comprises a sequence of local unitary operators, and the plurality of quantum algorithms comprises for each local unitary operator of the description of the system unitary evolution in terms of local operators a quantum algorithm that requires a single auxiliary quantum system associated with the one local unitary operator so as to form a series of quantum algorithms from an initial quantum algorithm that is associated with an initial local unitary operator and includes an initial total unitary evolution that comprises the controlled application of the initial local unitary operator to its corresponding subsystem controlled by the quantum state of the auxiliary quantum system to a final quantum algorithm of the series of quantum algorithms, wherein a subsequent total unitary evolution of a subsequent quantum algorithm of the series of quantum algorithms differs from a preceding total unitary evolution of a preceding quantum algorithm of the series of quantum algorithms in that a control is removed from a previously controlled local unitary operator associated with the preceding quantum algorithm and a controlled application of a local unitary operator associated with the subsequent quantum algorithm to its corresponding subsystem is added at a position in accordance with the sequence of local unitary operators.

13. The method according to claim 1, wherein the description of the system unitary evolution comprises a set of local Hamiltonian operators, and wherein the plurality of quantum algorithms comprises for each of the local Hamiltonians and each of a plurality of points In time an associated quantum algorithm that requires a single auxiliary quantum system associated with the one local Hamiltonian, wherein the total unitary evolution comprises an evolution of the quantum system under the system unitary evolution up to the point in time, and the joint action of the total unitary evolution comprises the controlled application of an operator derived from the local Hamiltonian operator to its corresponding subsystem controlled by the quantum state of the auxiliary quantum system.

14. The method according to claim 1, wherein the auxiliary quantum measurement comprises for at least one auxiliary quantum system an independent measurement of the auxiliary quantum system resulting in a measurement outcome associated therewith, and wherein depending on an appropriate post-selection of the associated measurement outcome an action of the joint unitary evolution on the corresponding subsystem of its associated local operator comprises an imaginary time evolution determined by the local operator, and the method comprises the appropriate post-selection.

15. The method according to claim 14, wherein the plurality of quantum algorithms comprises for each of a plurality of points in time an associated quantum algorithm that requires for each local operator of the description of the system unitary evolution an associated auxiliary quantum system, the quantum measurement comprises for each auxiliary quantum system an independent quantum measurement, and wherein depending on an appropriate post-selection of the associated measurement outcome of each auxiliary quantum measurement the action of the total unitary evolution on each subsystem comprises the imaginary time evolution determined by its corresponding local operator, and wherein the joint unitary evolution further comprises an evolution of the quantum system under the system unitary evolution up to the point in time.

16. A hybrid quantum-classical computing system, the computing system comprising a classical processor and a quantum processor, wherein the system is configured to:
receive, by the quantum processor, a plurality of quantum algorithms for estimating an overlap of a reference quantum state and an evolved quantum state of a quantum system, the evolved quantum state resulting from an evolution of an initial quantum state of the quantum system under a system unitary evolution having a description in terms of local operators that act on corresponding local subsystems of the quantum system, wherein each of the quantum algorithms requires at least one dedicated auxiliary quantum system associated with one of the local operators in a one-to-one correspondence;
execute, by the quantum processor, each of the plurality of quantum algorithms to thereby obtain a plurality of computational results indicative of a data series of phase information of the overlap, wherein the execution of each quantum algorithm comprises: providing a total system including the quantum system prepared in the initial quantum state and the at least one auxiliary quantum system prepared in an initial auxiliary quantum state;
evolving the total quantum system under a total unitary evolution, wherein a joint action of the total unitary evolution on the quantum system and the at least one auxiliary quantum system is limited to each auxiliary quantum system and the corresponding subsystem of its associated local operator and determined by associated the local operator;
applying a projective quantum measurement onto the reference quantum state to the quantum system and applying an auxiliary quantum measurement to the at least one auxiliary quantum system to thereby obtain the computational result;
receive, by the classical processor, the plurality of computational results, and to estimate, by the classical processor, at least a phase of the overlap on the basis of the computational results.

17. A computer program product comprising instructions, which, when the computer program product is executed on a quantum processor, cause the quantum processor to carry out the method according to claim 1.

18. A computer-readable storage medium comprising instructions which, when executed by a quantum processor, cause the quantum processor to carry out the method of claim 1.
